(19) United States
(12) Patent Application Publication
(10) Pub. No.: US 2006/0130405 A1
(43) Pub. Date: Jun. 22, 2006

(54) Assembly comprising a window regulator drive and a motor/gear unit connected thereto

(75) Inventors: Stephane Hemond, Les Bordes (FR); Franck Corgier, Aubigny sur Nere (FR)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Light Vehicle Systems-France

(21) Appl. No.: 11/264,870

(22) Filed: Nov. 2, 2005

(30) Foreign Application Priority Data
Dec. 20, 2004 (DE) 10 2004 061 254.4

(51) Int. Cl. E05F 15/16

(52) U.S. Cl. 49/352; 49/349

(57) ABSTRACT

An assembly includes a window regulator drive and a motor/gear unit connected to the window regulator drive. The assembly comprises a fastening mechanism adapted to engage a vehicle structure, and a latching mechanism that connects the motor/gear unit to the window regulator drive.

### BACKGROUND OF THE INVENTION

The application claims priority to German Application No. 10 2004 061 254.4 which was filed on Dec. 20, 2004.

The invention relates to an assembly including a window regulator drive and a motor/gear unit connected to the window regulator drive, wherein the assembly is particularly useful for a window regulator system for vehicles.

The window regulator drive usually comprises a drum for a driving cable. Rotation of the drum results in a displacement of the driving cable, which in turn results in displacement of a window pane, in particular of a window pane for a motor vehicle. The window regulator drive is usually fixed to a vehicle structure, for example a door structure, on a wet side. The term “wet side” designates an area of the vehicle door that is subject to humidity, for example due to water drops that pass through a seal engaging the displaceable window pane. An opposite side of the vehicle structure is a dry side. The dry side is sealed from the wet side so that no unwanted humidity is allowed to enter. Typically, a motor/gear unit is arranged on the dry side of the vehicle structure. This allows a motor to be used for driving the window regulator drive, which is not entirely encapsulated.

Since the window regulator drive is arranged on the wet side, the interface between the window regulator drive and the motor/gear unit must be fully watertight so as to prevent water from entering the dry side from the wet side. Further, the motor/gear unit should be removable without having to remove the window regulator drive. This allows replacement of the motor/gear unit in case of malfunction without having to remove the window regulator drive as well. Finally, it is desirable that the motor/gear unit can be assembled manually on a door mounting line, with no additional fastening element being needed.

### SUMMARY OF THE INVENTION

The invention achieves the above-referenced objectives by providing an assembly with a window regulator drive and a motor/gear unit connected to the window regulator drive. The assembly comprises a fastening mechanism adapted to engage a vehicle structure, and latching mechanism for connecting the motor/gear unit to the window regulator drive. The fastening mechanism associated with the vehicle structure is formed independent from the latching mechanism, thus the motor/gear unit can be connected to the window regulator drive and removed therefrom without having to disconnect the window regulator drive from the vehicle structure.

According to a preferred embodiment, the fastening mechanism and the latching mechanism are provided on a housing of the window regulator drive. This provides integration of all attachment elements into a single component so that the constraints resulting therefrom (e.g. material and manufacturing process) affect a single component only. This results in low manufacturing costs for the assembly.

Preferably, the fastening mechanism and the latching mechanism are arranged adjacent an accommodation space for a cover, the cover blocking the fastening mechanism and the latching mechanism. This reliably prevents the fastening mechanism and the latching mechanism from disengaging from the vehicle structure and the motor/gear unit, respectively, after the assembly is completely mounted.

These and other features of the present invention can be best understood from the following specification and drawings, the following of which is a brief description.

### BRIEF DESCRIPTION OF THE DRAWINGS

FIG. 1 shows a window regulator drive.

FIG. 2 shows the window regulator drive of FIG. 1 attached to a vehicle structure.

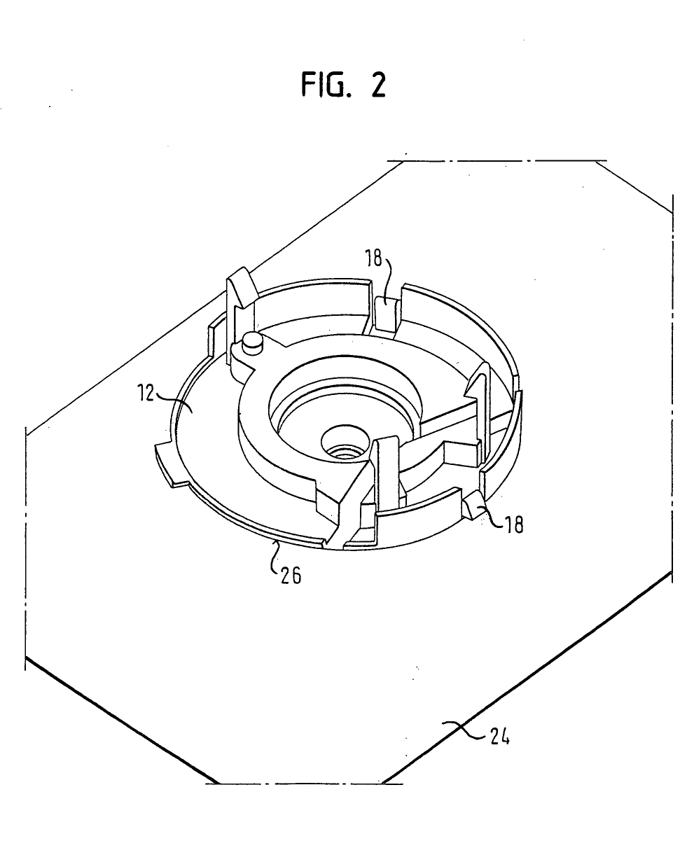

FIG. 3 shows the window regulator drive of FIG. 2 with a motor/gear unit connected thereto.

FIG. 4 shows the assembly of FIG. 3 with a cover mounted thereto.

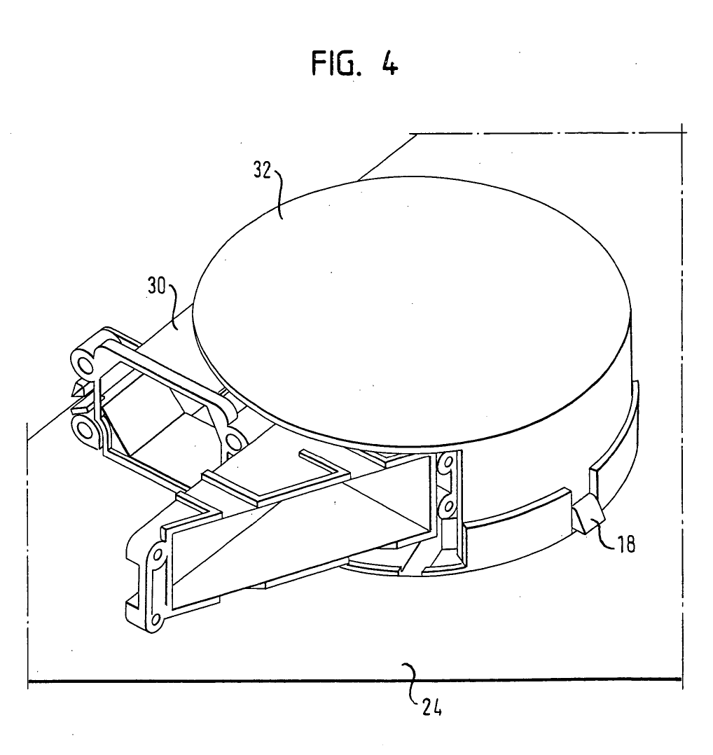

### DETAILED DESCRIPTION OF THE PREFERRED EMBODIMENT

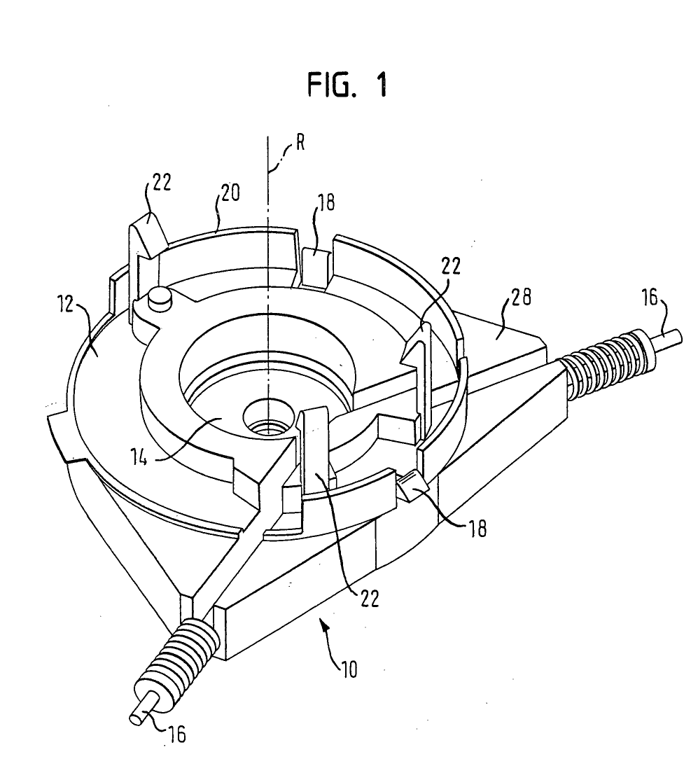

FIG. 1 shows a window regulator drive having a housing 12 in which a drum 14 is arranged. Drum 14 cooperates with one or two driving cables 16 that are typically connected to a cursor, which in turn is connected to a window pane (not shown) that is to be displaced by the window regulator drive. Housing 12 comprises a fastening mechanism 18 that is formed integrally therewith, and is formed as hooks extending in a direction from the housing 12 that is in parallel with an axis of rotation R of drum 14. Fastening mechanism 18 is arranged on the same radius with respect to the axis of rotation R of drum 14 as a flange 20. The purpose of the flange 20 will be discussed below.

Housing 12 further comprises a latching mechanism 22 that is also formed integrally with housing 12 and has the shape of hooks. Latching mechanism 22 also extends in a direction that is parallel to the axis of rotation R of drum 14.

In a first mounting step, window regulator drive 10 is attached to a separating wall 24 that separates a wet area from a dry area of a vehicle. Separating wall 24 is in particular a structure within a door of a vehicle. Window regulator drive 10 is attached on the wet side of the separating wall 24 such that flange 20 extends through an opening 26 in the separating wall 24. Upon mounting the window regulator drive 10 to the separating wall 24, the fastening mechanism 18 is elastically deflected radially inwardly when pushed through opening 26 in the separating wall 24.

In a completely mounted condition, the hooks of the fastening mechanism 18 elastically snap back into their original position so that housing 12 of window regulator drive 10 is firmly held within the opening 26 of the separating wall 24. In this condition, an upper surface 28 (see FIG. 1) of the housing 12 of the window regulator drive 10 contacts a surface of the separating wall 24 on the wet side.

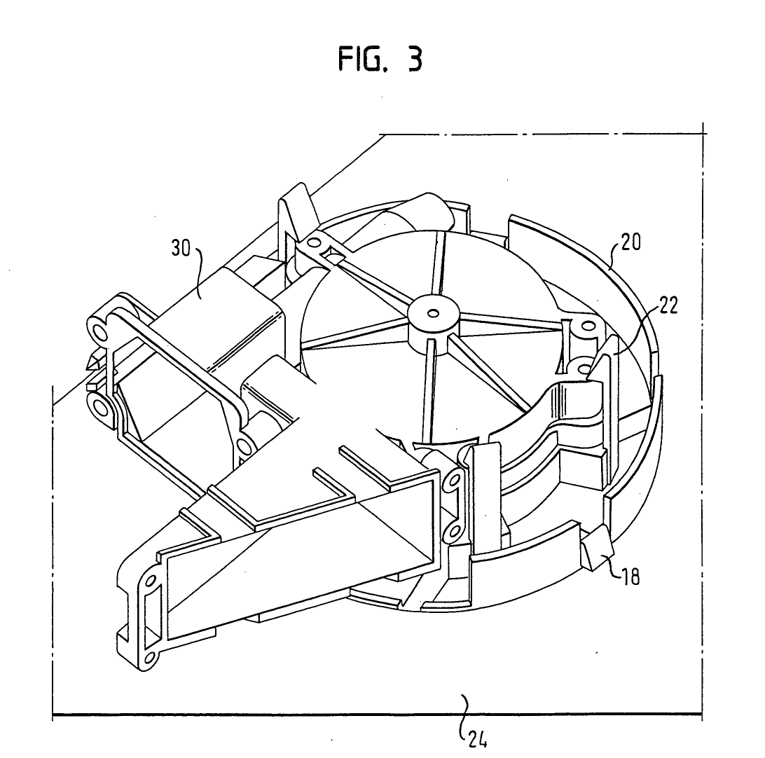

In a subsequent mounting step (see FIG. 3), a motor/gear unit 30 (shown schematically) is attached to the window regulator drive 10. Motor/gear unit 30 is pushed onto the window regulator drive 10 from the dry side of the separating wall 24 so that a driving shaft of motor/gear unit 30 mechanically engages into drum 14. During the step of mounting motor/gear unit 30 to window regulator drive 10, the hooks of the latching mechanism 22 are elastically deflected radially outwardly until they snap back into their original position, thereby engaging an outer surface of the motor/gear unit 30 to firmly latch the motor/gear unit 30 to the window regulator drive 10. This condition is shown in FIG. 3.

As a last mounting step, a cover 32 is clipped onto the assembly that includes the window regulator drive 10 and the motor/gear unit 30. The cover 32 comprises a cylindrical plate and a skirt portion, the skirt portion being arranged in an annular accommodation space that is formed between flange 20 and latching mechanism 22. The skirt portion of cover 32 both prevents the fastening mechanism 18 from being deflected radially inwardly, and latching mechanism 22 from being deflected radially outwardly. In other words, the cover 32 acts as a blocking element that ensures that the fastening mechanism and the latching mechanism 22 remain in their positions engaging the respective counterpart.

If motor/gear unit 30 is to be replaced for some reason, it is possible to first remove the cover 32 and then to remove the motor/gear unit 30 by spreading apart the hooks of latching mechanism 22 so that the motor/gear unit 30 can be removed from the window regulator drive 10. The window regulator drive 10 as such remains firmly secured within opening 26 of separating wall 24.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An assembly comprising:
a window regulator drive; and
a motor/gear unit connected to the window regulator drive, wherein the assembly comprises a fastening mechanism adapted to engage a vehicle structure, and a latching mechanism that connects the motor/gear unit to the window regulator drive.

2. The assembly of claim 1 wherein the fastening mechanism is provided on a housing of the window regulator drive.

3. The assembly of claim 2 wherein the housing is formed from a plastic material.

4. The assembly of claim 1 wherein the fastening mechanism comprises hooks.

5. The assembly of claim 1 wherein the latching mechanism is provided on a housing of the window regulator drive.

6. The assembly of claim 5 wherein the latching mechanism comprises hooks.

7. The assembly of claim 1 wherein the latching mechanism and the fastening mechanism are arranged such that when the fastening mechanism engages the vehicle structure and the latching mechanism engages the motor/gear unit the fastening and the latching mechanisms are deflected in opposite directions.

8. The assembly of claim 7 wherein the fastening mechanism and the latching mechanism are arranged such that the deflection of said fastening mechanism is radially inwardly and the deflection of said fastening mechanism is radially outwardly.

9. The assembly of claim 1 wherein the fastening mechanism and the latching mechanism are arranged adjacent an accommodation space for a cover, the cover blocking the fastening mechanism and the latching mechanism.

10. The assembly of claim 9 wherein the accommodation space extends along an arc of a circle, the fastening mechanism being arranged outside the cover and the latching mechanism being arranged inside the cover.

11. The assembly of claim 9 wherein the cover is clipped onto a housing of the window regulator drive such that the motor/gear unit is covered.

12. The assembly of claim 1 wherein the window regulator drive includes a housing and wherein the fastening mechanism and the latching mechanism are formed as part of the housing.

13. The assembly of claim 12 wherein the fastening mechanism comprises a first plurality of hooks and the latching mechanism comprises a second plurality of hooks spaced radially inwardly on the housing relative to the first plurality of hooks.

14. The assembly of claim 13 wherein the first and second pluralities of hooks each include a portion that extends parallel to an axis of rotation defined by a drum received within the housing.
